(19) United States
(12) Patent Application Publication
(10) Pub. No.: US 2023/0335730 A1
(43) Pub. Date: Oct. 19, 2023

(54) COMPOSITES WITH SURFACE REFINING AND CONFORMAL GRAPHENE COATING, ELECTRODES, AND FABRICATING METHODS OF SAME

(71) Applicant: NORTHWESTERN UNIVERSITY, Evanston, IL (US)

(72) Inventors: Mark C. Hersam, Wilmette, IL (US); Jin-Myoung Lim, Coppell, TX (US); Norman S. Luu, Chicago, IL (US)

(21) Appl. No.: 18/029,432

(22) PCT Filed: Oct. 4, 2021
(86) PCT No.: PCT/US2021/053312

§ 371 Date: Mar. 30, 2023

Related U.S. Application Data
(60) Provisional application No. 63/087,385, filed on Oct. 5, 2020.

(51) Int. Cl. H01M 4/525; H01M 4/62; H01M 4/04; H01M 4/485

(52) U.S. Cl. CPC H01M 4/525; H01M 4/625; H01M 4/0471; H01M 4/485; H01M 2004/021

(57) ABSTRACT

A composite and an electrode made of the same. The composite includes nanoparticles of an active material, said nanoparticles being surface refined by a post-synthetic annealing treatment to remove or minimize surface impurities thereon; and conformal graphene coating on each surface of said nanoparticles.

### CROSS-REFERENCE TO RELATED PATENT APPLICATION

This application claims priority to and the benefit of U.S. Provisional Application Ser. No. 63/087,385, filed Oct. 5, 2020, which is incorporated herein in its entirety by reference.

### STATEMENT AS TO RIGHTS UNDER FEDERALLY-SPONSORED RESEARCH

This invention was made with government support under DEAC02-06CH11357 awarded by the Department of Energy, and 1727846 and 1720139 awarded by the National Science Foundation. The government has certain rights in the invention.

### FIELD OF THE INVENTION

The present invention relates generally to energy storage, and more particularly to composites with surface refining and conformal graphene coating, electrodes, and fabricating methods and applications of the same.

### BACKGROUND OF THE INVENTION

The background description provided herein is for the purpose of generally presenting the context of the invention. The subject matter discussed in the background of the invention section should not be assumed to be prior art merely as a result of its mention in the background of the invention section. Similarly, a problem mentioned in the background of the invention section or associated with the subject matter of the background of the invention section should not be assumed to have been previously recognized in the prior art. The subject matter in the background of the invention section merely represents different approaches, which in and of themselves may also be inventions. Work of the presently named inventors, to the extent it is described in the background of the invention section, as well as aspects of the description that may not otherwise qualify as prior art at the time of filing, are neither expressly nor impliedly admitted as prior art against the invention.

As society transitions towards a renewable energy infrastructure, lithium-ion batteries (LIBs) have emerged as attractive power sources for key applications such as electric vehicles and consumer electronics. By tailoring the electrode materials, LIBs can be rationally designed to possess electrochemical properties that are customized for specific commercial technologies. For example, electric vehicles require high-power performance for fast acceleration, high-energy performance for long drivable range, and long cell lifetimes to minimize the need for cumbersome battery replacement. Consequently, significant efforts in LIB research have been focused on developing stable, high-capacity, and high-rate electrode materials.

Layered lithium transition metal oxides, especially nickel-rich chemistries such as LiNi_{0.8}Al_{0.15}Co_{0.05}O₂ (NCA), have emerged as leading LIB cathode material candidates due to their high operating potentials, high capacities, smooth voltage profiles, and facile synthesis. However, the adoption of these materials in high-power commercial applications has been hindered by poor rate performance, which can partially be attributed to relatively slow lithium-ion bulk diffusivities. Therefore, to achieve the high electrode power density and rate performance demanded by electric vehicles, a seemingly attractive strategy is to shrink the active material particle size to both decrease lithium-ion bulk diffusion lengths and increase the number of charge transfer sites.

Despite the apparent advantages of nanoparticle-based LIB electrodes, this approach introduces its own challenges. In addition to difficulty in packing nanoparticles and conventional carbon black conductive additives into dense electrodes, the increased surface area associated with smaller particle sizes increases the severity of degradation mechanisms driven by surface impurities, which are found as byproducts of materials synthesis and are generated as components of interfacial layers that form during electrochemical cycling. Residual surface impurities are especially problematic for nickel-rich layered oxides, suggesting that the active material surface chemistry needs to be carefully characterized and controlled in order to achieve high-performance nanoparticle-based LIB cathodes. For example, lithium carbonates and hydroxides left over from materials synthesis often contaminate nickel-rich oxide surfaces, which leads to high electrode polarization, reduced first-cycle efficiency, and compromised cell lifetimes. Furthermore, during cycling, electrolyte decomposition products, including solvent and salt components from the liquid electrolyte, deposit on and react with the active material surface, forming a solid-electrolyte interphase (SEI). Upon repeated cycling, the accumulation of these compounds increases the impedance of the SEI, which is detrimental to electrochemical properties and cyclic stability.

To address the surface impurities formed during materials synthesis, methods such as acid rinsing, aqueous treatments, treatments under vacuum, or electrochemical regeneration have been employed to improve the long-term cycle life of LIBs. Although these methods are effective for research-scale studies on nickel-rich cathode microparticles, they are cumbersome for large-scale materials production and are often ineffective for nanoparticle systems that possess high surface areas, and therefore, greater amounts of impurity species. Additionally, to mitigate the formation of surface degradation products in operando, thin surface coating layers have been employed to further stabilize nickel-rich cathode particle surfaces by preventing direct electrode-electrolyte contact while remaining electrochemically inert within the operating voltage window of the cell. In particular, coatings such as Al₂O₃, TiO₂, SiO₂, and Co₃O₄ can be deposited via facile, scalable techniques such as atomic layer deposition or wet chemical methods. However, these strategies are inherently limited by the poor electrical conductivity of the deposited oxide layers. In contrast, a thin, conductive carbon coating (e.g., graphene) can limit the formation of a thick SEI layer and improve charge-discharge kinetics. Moreover, since graphene coating schemes minimize the need for additional conductive additives, they are known to increase electrode tap density, which is particularly helpful in overcoming packing density limitations that have traditionally plagued nanoparticle-based electrodes.

Therefore, a heretofore unaddressed need exists in the art to address the aforementioned deficiencies and inadequacies.

### SUMMARY OF THE INVENTION

One aspect of this invention discloses a composite for an electrode for an electrochemical device. The composite comprises nanoparticles of an active material, said nanoparticles being surface refined by a post-synthetic annealing treatment to remove or minimize surface impurities thereon; and conformal graphene coating on each surface of said nanoparticles.

In one embodiment, the active material comprises nickel-rich transition metal oxides, cobalt-rich transition metal oxides, and lithium-rich transition metal oxides.

In one embodiment, the nickel-rich transition metal oxides comprise nickel-rich lithium oxides, nickel-rich sodium oxides, or nickel-rich magnesium oxides.

In one embodiment, the nickel-rich lithium oxides comprise LiNi_{0.8}Co_{0.15}Al_{0.05}O₂ (NCA), LiNiO₂ (LNO), LiMn_{1.5}Ni_{0.5}O₄ (LMNO), LiNiₓMn_{y}Co_{z}O₂ (NMC, wherein x+y+z=1), LiNi_{0.8}Co_{0.2}O₂ (LNCO), or Li_{w}NiₓMn_{y}Co_{z}O₂ (lithium-rich NMC, wherein w>1, x+y+z=1).

In one embodiment, the nickel-rich lithium oxides are doped with elements including Al, B, Zr, Nb, Fe, Cr, Cu, Mo, W, and/or V.

In one embodiment, the post-synthetic annealing treatment is performed by annealing at a temperature in a range of about 150-350° C. in an oxidizing environment for about 0.5-2 hours to effectively refine the surfaces of said nanoparticles.

In one embodiment, the post-synthetic annealing treatment does not produce any measurable changes to the bulk structure of said nanoparticles.

In one embodiment, the graphene comprises solution-exfoliated graphene.

In one embodiment, the conformal graphene coating yields a highly percolating, electrically conductive network between said nanoparticles.

In one embodiment, the composite further comprises amorphous carbon with sp²-carbon content.

In one embodiment, the amorphous carbon is an annealation product of ethyl cellulose.

In one embodiment, the composite is formed by annealing a mixture of said nanoparticles, said graphene, and ethyl cellulose at a temperature for a period of time to decompose the ethyl cellulose, thereby resulting in said composite having said annealation product of the ethyl cellulose.

In another aspect, the invention relates to an electrode for an electrochemical device, comprising said composite as disclosed above.

In one embodiment, the electrode has superlative performance including high rate capability, low impedance, high volumetric energy and power densities, and long cycle life, compared with a control electrode that comprises nanoparticles of the active material without surface refining and/or conformal graphene coating.

In one embodiment, the electrode has electrode polarization during activation lower than that of the control electrode.

In one embodiment, the electrode has initial capacity and rate capability better than that of the control electrode.

In one embodiment, the electrode has electrochemical reversibility better than that of the control electrode.

In one embodiment, the electrode has cell impedance substantially lower than that of the control electrode.

In yet another aspect, the invention relates to an electrochemical device, comprising the electrode as disclosed above.

In one aspect, the invention relates to a method for forming a composite for an electrode for an electrochemical device. The method includes providing nanoparticles of an active material; annealing said nanoparticles to remove or minimize surface impurities thereon to form surface refined nanoparticles; forming a mixture comprising said surface refined nanoparticles, graphene, and EC; and annealing the mixture to decompose the EC, thereby resulting in said composite having a conformal graphene coating on each surface of said surface fined nanoparticles.

In one embodiment, said annealing said nanoparticles comprises annealing said nanoparticles at a temperature in a range of about 150-350° C. in an oxidizing environment for about 0.5-2 hours to effectively refine the surfaces of said nanoparticles.

In one embodiment, said annealing the mixture comprises annealing the mixture at a temperature in a range of about 150-350° C. for about 0.5-2 hours to effectively decompose the ethyl cellulose.

In one embodiment, the graphene comprises solution-exfoliated graphene.

In one embodiment, the active material comprises nickel-rich transition metal oxides.

In one embodiment, the nickel-rich transition metal oxides comprise nickel-rich lithium oxides, nickel-rich sodium oxides, or nickel-rich magnesium oxides.

In one embodiment, the nickel-rich lithium oxides comprise NCA, LNO, LMNO, NMC, LNCO, or lithium-rich NMC.

In one embodiment, the nickel-rich lithium oxides are doped with elements including Al, B, Zr, Nb, Fe, Cr, Cu, Mo, W, and/or V.

In another aspect, the invention relates to method for forming an electrode for an electrochemical device. The method comprises providing nanoparticles of an active material; annealing said nanoparticles to remove or minimize surface impurities thereon to form surface refined nanoparticles; forming a slurry comprising said surface refined nanoparticles, graphene, EC, and a carbon material; casting the slurry onto a substrate and drying the casted slurry to form an electrode; and annealing the electrode to decompose the EC, thereby resulting in each surface of said surface refined nanoparticles coupled to and conformally coated with the graphene.

In one embodiment, said annealing said nanoparticles comprises annealing said nanoparticles at a temperature in a range of about 150-350° C. in an oxidizing environment for about 0.5-2 hours to effectively refine the surfaces of said nanoparticles.

In one embodiment, said annealing the electrode comprises annealing the electrode at a temperature in a range of about 150-350° C. for about 0.5-2 hours to effectively decompose the ethyl cellulose.

In one embodiment, said annealing the electrode to decompose the EC results in a carbonaceous residue on the active material surface that possesses sp²-carbon content.

In one embodiment, the graphene comprises solution-exfoliated graphene.

In one embodiment, the substrate comprises an aluminum foil, or the like.

In one embodiment, the carbon material comprises multiwalled carbon nanotubes (MWCNT), single-walled carbon nanotubes (SWCNT), fullerenes, or carbon black.

In one embodiment, a weight ratio of solids in the slurry is about 95% surface refined nanoparticles, about 4.5% graphene, and about 0.5% MWCNT.

In one embodiment, the active material comprises nickel-rich transition metal oxides.

In one embodiment, the nickel-rich transition metal oxides comprise nickel-rich lithium oxides, nickel-rich sodium oxides, or nickel-rich magnesium oxides.

In one embodiment, the nickel-rich lithium oxides comprise NCA, LNO, LMNO, NMC, LNCO, or lithium-rich NMC.

In one embodiment, the nickel-rich lithium oxides are doped with elements including Al, B, Zr, Nb, Fe, Cr, Cu, Mo, W, and/or V.

These and other aspects of the present invention will become apparent from the following description of the preferred embodiment taken in conjunction with the following drawings, although variations and modifications therein may be affected without departing from the spirit and scope of the novel concepts of the invention.

### BRIEF DESCRIPTION OF THE DRAWINGS

The accompanying drawings illustrate one or more embodiments of the invention and together with the written description, serve to explain the principles of the invention. Wherever possible, the same reference numbers are used throughout the drawings to refer to the same or like elements of an embodiment.

FIG. 1 shows characterization and control of nanoscale NCA (nNCA) surface chemistry, according to embodiments of the invention. Panel a: X-Ray diffraction (XRD) patterns of nNCA and commercial NCA powder. Panels b-c: Scanning electron microscope (SEM) images of as-synthesized NCA at different magnifications. Panel d: Schematic showing removal of impurities at the NCA particle surface during heat treatment, yielding nanoscale NCA with a refined surface (R-nNCA). Panel e: C is spectra of nNCA and R-nNCA powders obtained via X-Ray photoelectron spectroscopy (XPS). Panel f: O 1s spectra of nNCA and R-nNCA powders obtained via XPS. Panel g: Voltage-capacity plot showing the activation cycles of nNCA and R-nNCA at 0.1 C.

FIG. 2 shows results for conformal graphene coatings, according to embodiments of the invention. Panel a: Schematic showing that a conformal graphene coating will encapsulate surface impurities on nNCA (Gr-nNCA), in contrast to a conformal graphene coating on a refined, impurity-free surface (Gr-R-nNCA). Panels b-c: Transmission electron microscopy (TEM) images showing the surface of the Gr-R-nNCA particles. Panel d: Half-cell rate capability test of nNCA, R-nNCA, Gr-nNCA, and Gr-R-nNCA electrodes. Panel e: Raman spectra for Gr-nNCA and Gr-R-nNCA. Panel f: C 1s spectra of Gr-nNCA and Gr-R-nNCA obtained via XPS. Panel g: O is spectra of Gr-nNCA and Gr-R-nNCA obtained via XPS.

FIG. 3 shows graphene-coated nanoscale NCA exhibits improved cycle life compared to the control, according to embodiments of the invention. Panel a: Half-cell cycle life test at 1 C. Panel b: O 1s, Panel c: Ni 2p, and Panel d: Co 2p postmortem XPS spectra show significant evidence of degradation for the uncoated nNCA electrode.

FIG. 4 shows electrochemical testing, which demonstrates that graphene-coated Gr-R-nNCA electrodes enable comprehensive performance improvements compared to the nNCA control, according to embodiments of the invention. Panel a: Half-cell volumetric rate capability test. Panel b: Nyquist plot of the electrodes at room temperature. Panel c: Full-cell rate capability test at 0° C. Panel d: Nyquist plot of the full cells at 0° C. Panel e: Ragone plot showing the improved power and energy density of the Gr-R-nNCA electrode. Panel f: Plot showing the power density competitive advantage of Gr-R-nNCA electrodes compared to literature precedent. The numbers indicate the references for previous reported results.

FIG. 5 shows scanning electron microscope image of commercial NCA powder (Toda America) showing a large, micron-scale secondary particle morphology, according to embodiments of the invention.

FIG. 6 shows X-ray diffraction pattern of the refined nNCA particles, showing negligible change in the bulk layered structure after the post-synthetic surface refinement, according to embodiments of the invention.

FIG. 7 shows (left) Ni 2p and (right) Co 2p X-ray photoelectron spectra showing minimal changes in the transition metal oxidation states after the refining step and the graphene coating process, according to embodiments of the invention.

FIG. 8 shows postmortem XPS C is spectra for the Gr-R-nNCA electrode and the nNCA electrode, according to embodiments of the invention.

FIG. 9 shows postmortem Raman spectrum of the Gr-R-nNCA electrode showing that the graphene coating is preserved after 200 charge-discharge cycles, according to embodiments of the invention.

### DETAILED DESCRIPTION OF THE INVENTION

The invention will now be described more fully hereinafter with reference to the accompanying drawings, in which exemplary embodiments of the invention are shown. This invention may, however, be embodied in many different forms and should not be construed as limited to the embodiments set forth herein. Rather, these embodiments are provided so that this specification will be thorough and complete, and will fully convey the scope of the invention to those skilled in the art. Like reference numerals refer to like elements throughout.

The terms used in this specification generally have their ordinary meanings in the art, within the context of the invention, and in the specific context where each term is used. Certain terms that are used to describe the invention are discussed below, or elsewhere in the specification, to provide additional guidance to the practitioner regarding the description of the invention. For convenience, certain terms may be highlighted, for example using italics and/or quotation marks. The use of highlighting has no influence on the scope and meaning of a term; the scope and meaning of a term are the same, in the same context, whether or not it is highlighted. It will be appreciated that same thing can be said in more than one way. Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and in no way limits the scope and meaning of the invention or of any exemplified term. Likewise, the invention is not limited to various embodiments given in this specification.

It will be understood that, as used in the description herein and throughout the claims that follow, the meaning of “a”, “an”, and “the” includes plural reference unless the context clearly dictates otherwise. Also, it will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

It will be understood that, although the terms first, second, third, etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the invention.

Furthermore, relative terms, such as “lower” or “bottom” and “upper” or “top,” may be used herein to describe one element's relationship to another element as illustrated in the figures. It will be understood that relative terms are intended to encompass different orientations of the device in addition to the orientation depicted in the figures. For example, if the device in one of the figures. is turned over, elements described as being on the “lower” side of other elements would then be oriented on “upper” sides of the other elements. The exemplary term “lower”, can, therefore, encompasses both an orientation of “lower” and “upper,” depending on the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

It will be further understood that the terms “comprises” and/or “comprising,” or “includes” and/or “including” or “has” and/or “having”, or “carry” and/or “carrying,” or “contain” and/or “containing,” or “involve” and/or “involving, and the like are to be open-ended, i.e., to mean including but not limited to. When used in this specification, they specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and this specification, and will not be interpreted in an idealized or overly formal sense unless expressly so defined herein.

As used in this specification, “around”, “about”, “approximately” or “substantially” shall generally mean within 20 percent, preferably within 10 percent, and more preferably within 5 percent of a given value or range. Numerical quantities given herein are approximate, meaning that the term “around”, “about”, “approximately” or “substantially” can be inferred if not expressly stated.

As used in this specification, the phrase “at least one of A, B, and C” should be construed to mean a logical (A or B or C), using a non-exclusive logical OR. As used herein, the term “and/or” includes any and all combinations of one or more of the associated listed items.

The description below is merely illustrative in nature and is in no way intended to limit the invention, its application, or uses. The broad teachings of the invention can be implemented in a variety of forms. Therefore, while this invention includes particular examples, the true scope of the invention should not be so limited since other modifications will become apparent upon a study of the drawings, the specification, and the following claims. For purposes of clarity, the same reference numbers will be used in the drawings to identify similar elements. It should be understood that one or more steps within a method may be executed in a different order (or concurrently) without altering the principles of the invention.

Layered, nickel-rich lithium transition metal oxides have emerged as leading candidates for lithium-ion battery (LIB) cathode materials. High-performance applications for nickel-rich cathodes, such as electric vehicles and grid-level energy storage, demand electrodes that deliver high power without compromising cell lifetimes or impedance. Nanoparticle-based nickel-rich cathodes seemingly present a solution to this challenge due to shorter lithium-ion diffusion lengths compared to incumbent micron-scale active material particles. However, since smaller particle sizes imply that surface effects become increasingly important, particle surface chemistry must be well characterized and controlled to achieve robust electrochemical properties. Moreover, residual surface impurities can disrupt commonly used carbon coating schemes, which results in compromised cell performance. In some embodiments, by using X-ray photoelectron spectroscopy, detailed characterization of the surface chemistry of LiNi_{0.8}Al_{0.15}Co_{0.05}O₂ (NCA) nanoparticles is presented, ultimately identifying surface impurities that limit LIB performance. With this chemical insight, annealing procedures are developed that minimize these surface impurities, thus improving electrochemical properties and enabling conformal graphene coatings that reduce cell impedance, maximize electrode packing density, and enhance cell lifetime. Overall, this invention demonstrates that controlling and stabilizing surface chemistry enables the full potential of nanostructured nickel-rich cathodes to be realized in high-performance LIB technology.

In one aspect, the invention relates to a composite for an electrode for an electrochemical device. In some embodiments, the electrochemical device is a battery such as an LIB. The composite comprises nanoparticles of an active material, said nanoparticles being surface refined by a post-synthetic annealing treatment to remove or minimize surface impurities thereon; and conformal graphene coating on each surface of said nanoparticles.

In one embodiment, the active material comprises nickel-rich transition metal oxides, cobalt-rich transition metal oxides, and lithium-rich transition metal oxides. In one embodiment, the nickel-rich transition metal oxides comprise nickel-rich lithium oxides, nickel-rich sodium oxides, or nickel-rich magnesium oxides. In one embodiment, the nickel-rich lithium oxides comprise NCA, LiNiO₂ (LNO), LiMn_{1.5}Ni_{0.5}O₄ (LMNO), LiNiₓMn_{y}Co_{z}O₂ (NMC, wherein x+y+z=1), LiNi_{0.8}Co_{0.2}O₂ (LNCO), or Li_{w}NiₓMn_{y}Co_{z}O₂ (lithium-rich NMC, wherein w >1, x+y+z=1). In one embodiment, the nickel-rich lithium oxides are doped with elements including Al, B, Zr, Nb, Fe, Cr, Cu, Mo, W, and/or V.

The nickel-rich transition metal oxides disclosed herein are a cathode active material, and the electrode is a cathode electrode. It should be appreciated that the electrode can also be an anode electrode incorporating an anode active material.

In one embodiment, the post-synthetic annealing treatment is performed by annealing at a temperature in a range of about 150-350° C. in an oxidizing environment for about 0.5-2 hours to effectively refine the surfaces of said nanoparticles. In one embodiment, the post-synthetic annealing treatment does not produce any measurable changes to the bulk structure of said nanoparticles.

In one embodiment, the graphene comprises solution-exfoliated graphene.

In one embodiment, the conformal graphene coating yields a highly percolating, electrically conductive network between said nanoparticles.

In one embodiment, the composite further comprises amorphous carbon with sp²-carbon content. In one embodiment, the amorphous carbon is an annealation product of ethyl cellulose. In one embodiment, the composite is formed by annealing a mixture of said nanoparticles, said graphene, and ethyl cellulose at a temperature for a period of time to decompose the ethyl cellulose, thereby resulting in said composite having said annealation product of the ethyl cellulose.

In another aspect, the invention relates to an electrode for an electrochemical device, comprising said composite as disclosed above.

In one embodiment, the electrode has superlative performance including high rate capability, low impedance, high volumetric energy and power densities, and long cycle life, compared with a control electrode that comprises nanoparticles of the active material without surface refining and/or conformal graphene coating.

In one embodiment, the electrode has electrode polarization during activation lower than that of the control electrode.

In one embodiment, the electrode has initial capacity and rate capability better than that of the control electrode.

In one embodiment, the electrode has electrochemical reversibility better than that of the control electrode.

In one embodiment, the electrode has cell impedance substantially lower than that of the control electrode.

In yet another aspect, the invention relates to an electrochemical device, comprising the electrode as disclosed above.

In one aspect, the invention relates to a method for forming a composite for an electrode for an electrochemical device including providing nanoparticles of an active material; annealing said nanoparticles to remove or minimize surface impurities thereon to form surface refined nanoparticles; forming a mixture comprising said surface refined nanoparticles, graphene, and EC; and annealing the mixture to decompose the ethyl cellulose, thereby resulting in said composite having a conformal graphene coating on each surface of said surface refined nanoparticles.

In another aspect, the invention relates to method for forming an electrode for an electrochemical device comprising providing nanoparticles of an active material; annealing said nanoparticles to remove or minimize surface impurities thereon to form surface refined nanoparticles; forming a slurry comprising said surface refined nanoparticles, graphene, EC, and a carbon material; casting the slurry onto a substrate and drying the casted slurry to form an electrode; and annealing the electrode to decompose the EC, thereby resulting in each surface of said surface refined nanoparticles coupled to and conformally coated with the graphene.

In one embodiment, said annealing said nanoparticles comprises annealing said nanoparticles at a temperature in a range of about 150-350° C. in an oxidizing environment for about 0.5-2 hours to effectively refine the surfaces of said nanoparticles.

In one embodiment, said annealing the mixture/electrode comprises annealing the mixture/electrode at a temperature in a range of about 150-350° C. for about 0.5-2 hours to effectively decompose the ethyl cellulose.

In one embodiment, the graphene comprises solution-exfoliated graphene.

In one embodiment, the active material comprises nickel-rich transition metal oxides. In one embodiment, the nickel-rich transition metal oxides comprise nickel-rich lithium oxides, nickel-rich sodium oxides, or nickel-rich magnesium oxides. In one embodiment, the nickel-rich lithium oxides comprise NCA, LNO, LMNO, NMC, LNCO, or lithium-rich NMC. In one embodiment, the nickel-rich lithium oxides are doped with elements including Al, B, Zr, Nb, Fe, Cr, Cu, Mo, W, and/or V.

In one embodiment, the substrate comprises an aluminum foil, or the like.

In one embodiment, the carbon material comprises multiwalled carbon nanotubes (MWCNT), single-walled carbon nanotubes (SWCNT), fullerenes, or carbon black. In one embodiment, a weight ratio of solids in the slurry is about 95% surface refined nanoparticles, about 4.5% graphene, and about 0.5% MWCNT.

In yet another aspect, the invention discloses a method for forming a graphene-coated electrode, comprising dispersing graphene-ethyl-cellulose (EC) powder and MWCNT in ethanol to form a first dispersion; adding N-methyl pyrrolidone (NMP) to the first dispersion and evaporating the ethanol to yield a second dispersion of graphene, ethyl cellulose, MWCNT and NMP; adding powder of surface refined nanoparticles to the second dispersion and mixing them homogeneously to form a slurry; casting the slurry onto a substrate and drying the casted slurry to form an electrode; and heating an electrode to a temperature for a period of time to decompose the EC, thereby resulting in the surface of each of the nanoparticles coupled to and conformally coated with the graphene.

In one embodiment, the thermal decomposition of the EC polymer leaves behind a carbonaceous residue on the active material surface that possesses high sp² character, thus reinforcing the graphitic character of the carbon coating.

In one embodiment, the carbonaceous residue is highly electrically conductive, thereby improving the electrical contact between adjacent graphene flakes and enhancing electrochemical cycling.

In one embodiment, the substrate comprises an aluminum foil, or the like.

In one embodiment, wherein the annealing temperature is about 150-350° C., and the period of time is for about 0.5-2 hours.

In one embodiment, a weight ratio of solids in the slurry is about 95% surface refined nanoparticles, about 4.5% graphene, and about 0.5% MWCNT.

In one embodiment, the powder of surface refined nanoparticles is obtained by a post-synthetic annealing treatment, wherein surface impurity species are removed through mild heating in an oxidizing environment.

In one embodiment, the surface refinement step does not produce any measurable changes to the bulk structure of the powder of the nanoparticles.

In one embodiment, the surface refined nanoparticles are synthesized by dissolving stoichiometric amounts of nickel (II) acetate tetrahydrate, cobalt (II) acetate tetrahydrate, and aluminum (II) acetate tetrahydrate in deionized water to form a precursor solution; dissolving oxalic acid dihydrate in deionized water to form an oxalic acid solution; dropwise addition of the oxalic acid solution into the precursor solution while simultaneously stirring to ensure homogeneous mixing; further simultaneously stirring the mixed solution and evaporating the water to yield precipitate powder; heating the precipitate powder at a first temperature for a first period of time under flowing oxygen to form calcined powder; mixing the calcined powder with excess lithium hydroxide monohydrate at until a homogeneous mixture is formed; calcining the homogeneous mixture at a second temperature for a second period of time and then at a third temperature for a third period of time under flowing oxygen to form nanoparticle powder; and refining the nanoparticles powder by a heat treatment step at a fourth temperature for a fourth period of time under flowing oxygen.

In one embodiment, the step of refining the nanoparticles removes or minimizes impurities on the surface the nanoparticles formed during synthesis.

In one embodiment, the surface refinement step does not produce any measurable changes to the bulk structure of the powder of the nanoparticles.

In one embodiment, the first temperature is about 350-550° C., and the first period of time is about 6-10 hours.

In one embodiment, the second temperature is about 450-650° C., the second period of time is about 6-10 hours, the third temperature is about 650-850° C., and the third period of time is about 12-36 hours.

In one embodiment, the fourth temperature is about 150-350° C., and the fourth period of time is about 0.5-1.5 hours.

In one embodiment, the graphene-EC powder is produced by shear mixing a mixture of flake graphite, ethyl cellulose, and ethanol to form a dispersion; centrifuging the dispersion to sediment out large, unexfoliated graphite flakes, thereby forming a first supernatant dispersion; flocculating the first supernatant dispersion with a sodium chloride solution to form a second dispersion, and then centrifuging the second dispersion to crash out the graphene-EC powder. In one embodiment, the second dispersion has 9:16 weight ratio of 1 mol NaCl solution:graphene dispersion.

In one embodiment, the graphene-EC powder is produced further by washing the powder with deionized water, vacuum filtering, and drying under an infrared environment.

In one embodiment, the graphene fraction in the graphene-EC powder is about 25-40%. In one embodiment, the surface refined nanoparticles comprise surface refined nanoparticles of nickel-rich transition metal oxides comprise nickel-rich lithium oxides, nickel-rich sodium oxides, or nickel-rich magnesium oxides.

In one embodiment, the nickel-rich lithium oxides comprise NCA, LNO, LMNO, NMC, LNCO, or lithium-rich NMC, and can be doped with elements including Al, B, Zr, Nb, Fe, Cr, Cu, Mo, W, V.

The invention, among other things, provides benefits and advantages over the existing art. The existing technologies to remove surface impurities, such as acid rinsing, aqueous treatments, vacuum processing, or electrochemical regeneration are cumbersome and cannot be easily translated to large-scale, roll-to-roll manufacturing processes. Since lithium-ion battery cathode synthesis already requires high-temperature heating steps, the quick, low-temperature thermal treatment procedure can be immediately implemented following materials synthesis without significant changes to processing conditions or significant capital expenditures. In addition, strategies to address in-operando interfacial degradation often utilize oxide coatings to limit contact between the cathode material and the liquid electrolyte, which slows electrolyte decomposition. However, these oxide coatings possess low electrical conductivity and therefore limit high-rate cycling. In contrast, the conductive graphene coating according to the invention significantly reduces the severity of electrolyte decomposition reactions while enabling superlative high-power performance. The thin, conformal graphene network also densifies the electrode, providing an additional boost to the volumetric power density.

The invention may find widespread applications in, but are not limited to, Li-ion batteries, graphene coating or graphene encapsulation, cathode materials, high power/high energy density electrode, conductive additives in electrodes, intercalation materials, and so on.

These and other aspects of the invention are further described below. Without intent to limit the scope of the invention, exemplary instruments, apparatus, methods, and their related results according to the embodiments of the invention are given below. Note that titles or subtitles may be used in the examples for convenience of a reader, which in no way should limit the scope of the invention. Moreover, certain theories are proposed and disclosed herein; however, in no way they, whether they are right or wrong, should limit the scope of the invention so long as the invention is practiced according to the invention without regard for any particular theory or scheme of action.

### EXAMPLE

### Enhancing Nanostructured Nickel-Rich Lithium-Ion Battery Cathodes Via Surface Stabilization

In this exemplary study, the surface chemical characterization is employed as a strategy for identifying and minimizing residual hydroxide and carbonate impurities from the synthesis of NCA nanoparticles. Using this surface chemical insight, post-synthetic processing methods are developed to minimize surface impurities and thus improve electrochemical properties. Furthermore, the improved pristineness of the NCA surface facilitates the conformal coating of the NCA nanoparticles with ultrathin conductive and chemically inert graphene. The resulting graphene-coated NCA nanoparticles are then formulated into LIB cathodes, which show superlative electrochemical properties, including low impedance, high rate performance, high volumetric energy and power densities, and long cycling lifetimes. In addition to being directly applicable to emerging nickel-rich LIB cathodes, the methodology presented here can be generalized to other LIB electrode materials that are synthesized with hydroxide-based or carbonate-based lithium sources, including oxide-based cathode, anode, and solid-state electrolyte materials.

### Sample Preparation

NCA Synthesis: NCA nanoparticles (nNCA) were synthesized via a solid-state method. Initially, stoichiometric amounts of nickel (II) acetate tetrahydrate, cobalt (II) acetate tetrahydrate, and aluminum (II) acetate tetrahydrate (Millipore Sigma) were dissolved in deionized water to form a 0.1 M precursor solution. Oxalic acid dihydrate (Millipore Sigma) was simultaneously dissolved in deionized water to form a 0.2 M oxalic acid solution. To precipitate the transition metal precursors, the oxalic acid solution was added dropwise to the precursor solution while stirring at about 300 RPM to ensure homogeneous mixing. After further stirring for about 3 hours, the water was evaporated using a rotary evaporator (Buchi Rotavapor R-300 System), yielding the precipitate powder. This powder was then heated in a tube furnace (Thermo Scientific Lindberg Blue M) at about 450° C. for about 8 hours under flowing oxygen. Using a mortar and pestle, the calcined powder was then mixed with lithium hydroxide monohydrate (Millipore Sigma) at an about 3% mol excess until a homogeneous mixture was formed. The combined powder was calcined at about 550° C. for about 8 hours and then about 750° C. for about 24 hours under flowing oxygen. The refined nanoparticle NCA powder (hereafter referred to as R-nNCA) was obtained by a final heat treatment step at about 250° C. under flowing oxygen for about 1 hour. All furnace ramp rates used were 5° C./min.

Graphene Exfoliation: Graphene-ethyl cellulose (EC) powder was produced by shear mixing 150 mesh flake graphite (Millipore Sigma), ethyl cellulose (4 cP, Millipore Sigma), and ethanol (200-proof, Decon Labs) for about 2 hours at about 10,230 RPM using a Silverson L5M-A high shear mixer. The dispersion was then centrifuged for about 2 hours at about 7,500 RPM in a Beckman Coulter J26 XPI centrifuge to sediment out large, unexfoliated graphite flakes. The supernatant dispersion was flocculated with a 1 M sodium chloride solution at a 9:16 weight ratio (NaCl solution:graphene dispersion), and then centrifuged again at about 7,500 RPM for about 6 minutes to crash out the graphene-EC powder. These solids were washed with deionized water, vacuum filtered, and dried under an infrared lamp. The final graphene fraction in the graphene-EC powder was about 33% as determined by thermogravimetric analysis in air.

Electrode Fabrication: The nNCA electrodes were fabricated by mixing nNCA powder, carbon black (Alfa Aesar), and polyvinylidene fluoride (MTI Corporation) at about a 90:5:5 weight ratio in a mortar and pestle. N-methyl pyrrolidone (NMP, Millipore Sigma) was added to form a viscous and homogeneous slurry. The slurry was cast on aluminum foil using a doctor blade, initially dried in a convection oven at about 120° C. for about 30 minutes, and subsequently dried in a vacuum oven at about 80° C. overnight. This process yielded electrodes with an active material loading of about 3 mg/cm². Electrode discs with about 1 cm diameter were cut using a disc cutter and then pressed using about 6 MPa of applied pressure prior to coin cell assembly. The R-nNCA electrodes were fabricated using the same method, with the R-nNCA powder serving as the active material. The graphite electrodes for the full cell testing were fabricated using identical methods but used natural graphite powder (Alfa Aesar) as the active material. The graphite slurry was cast on copper foil and dried at about 80° C. in the convection oven prior to overnight drying for the full cell experiments.

To form the graphene-coated electrodes, graphene-EC powder and multiwalled carbon nanotubes (MWCNT, Sigma) were dispersed in ethanol using a horn sonicator (Fisher Scientific Sonic Dismembrator Model 500) equipped with an about ⅛″ tip at about 40 W for about 1 hour. Solvent exchange was performed by adding NMP to this dispersion and evaporating the ethanol using a hot plate set at about 80° C., yielding a dispersion of graphene, ethyl cellulose, MWCNT, and NMP. R-nNCA powder was added to this dispersion to form a viscous slurry, which was mixed homogeneously using a mortar and pestle. The final weight ratio of solids in this slurry was about 95% active material, about 4.5% graphene, and about 0.5% MWCNT. This ratio was chosen to keep the conductive carbon fraction consistent with the control electrodes made with carbon black. After mixing, the slurry was cast onto aluminum foil and dried in a convection oven set at about 120° C. for about 30 minutes, and then dried again in a vacuum oven at about 80° C. overnight, yielding Gr-R-nNCA electrodes. Electrode discs with a diameter of about 1 cm and an active material loading of about 3 mg/cm² were cut and heated to about 250° C. for about 1 hour to decompose the EC. Following thermal decomposition, the electrodes were compressed with about 6 MPa of applied pressure prior to coin cell assembly. The Gr-nNCA electrodes were produced using the same method but instead using nNCA powder as the active material.

Electrode thicknesses were measured using a Mitutoyo micrometer. 2032-type coin cells were assembled in an argon glovebox (OMNI-LAB, Vacuum Atmospheres Company) with less than 0.2 ppm of oxygen. For room-temperature testing, Celgard 2325 was used as the separator, and 1 M LiPF₆ in 1:1 v/v ethylene carbonate/ethyl methyl carbonate (Millipore Sigma) was used as the electrolyte. For low-temperature testing, a polyethylene separator (single-layer PE, Asahi Kasei) and 1 M LiPF₆ in 1:1 v/v ethylene carbonate/dimethyl carbonate (Millipore Sigma) electrolyte were used. Lithium metal (Alfa Aesar) was used as the counter electrode for half-cell testing. For full-cell testing, graphite electrodes were used as the counter electrode.

### Characterization

Electrochemical Testing: Room-temperature galvanostatic cycling was performed using an Arbin LBT-20084 64-channel battery cycler. For half-cell testing, the NCA electrodes were activated with a constant-current constant-voltage (CCCV) protocol, where the electrode was cycled once at 0.1 C with constant-voltage holds at the upper and lower cutoff voltages until the current reached C/20. Here, 1 C was set at 170 mAh/g. For full-cell testing, the graphite anode was activated with 3 cycles between 0.01 V and 2 V vs. Li/Li⁺ using the same CCCV protocol to form a stable solid-electrolyte interphase on the anode. The graphite electrode was then harvested and assembled in a full cell against an activated NCA cathode. The negative to positive electrode areal capacity ratio (N:P ratio) was set at 1.1:1. Rate capability tests were performed using a charging current rate of 0.1 C, and then discharging at the desired current rate. Cycle life tests were performed at 1 C charge and discharge. Low-temperature testing was performed by cycling the coin cells in an environmental chamber (ESPEC BTX-475) set at about 0° C. Electrochemical impedance spectroscopy tests were conducted in a fully charged state using a Biologic VSP potentiostat between about 1 MHz and about 100 mHz.

Materials Characterization: X-ray diffraction (XRD) was conducted on the synthesized powders using a Scintag XDS2000 with Cu Kα (λ=1.5046 Å) radiation from about 10° to about 70°. The same analysis was performed on commercially available NCA powder (BASF Toda America). Scanning electron microscopy (SEM) was performed using a Hitachi SU8030 Field Emission SEM at an about 5 kV accelerating voltage. SEM samples were prepared by depositing the NCA powder directly onto carbon tape mounted on an SEM stub. Transmission electron microscopy (TEM) samples were prepared by a direct application of the Gr-R-nNCA powder on a lacey carbon supported TEM grid. The TEM imaging was performed using a JEOL ARM 300CF Raman spectroscopy was conducted using a Horiba Scientific XploRA PLUS Raman microscope with a laser excitation of about 532 nm and a laser grating with about 1800 grooves/mm. The signal was collected by a 50×LWD Olympus objective (NA=0.5). X-ray photoelectron spectroscopy (XPS) was performed using a Thermo Scientific ESCALAB 250Xi with Al Kα radiation (about 1486.6 eV). Spectra were acquired after the analysis chamber reached a base pressure of about 5×10⁻⁸ Torr. The samples were mounted using copper tape and were charge compensated with a flood gun during acquisition. All spectra were charge corrected to adventitious carbon at about 284.8 eV. Postmortem analysis of the battery electrodes was conducted by disassembling the coin cells in an argon glovebox. The harvested electrodes were rinsed with anhydrous dimethyl carbonate (Sigma) and dried at about 120° C. on a hot plate in the glovebox. Postmortem XPS and Raman spectra were acquired using the aforementioned methods.

### Results and Discussion

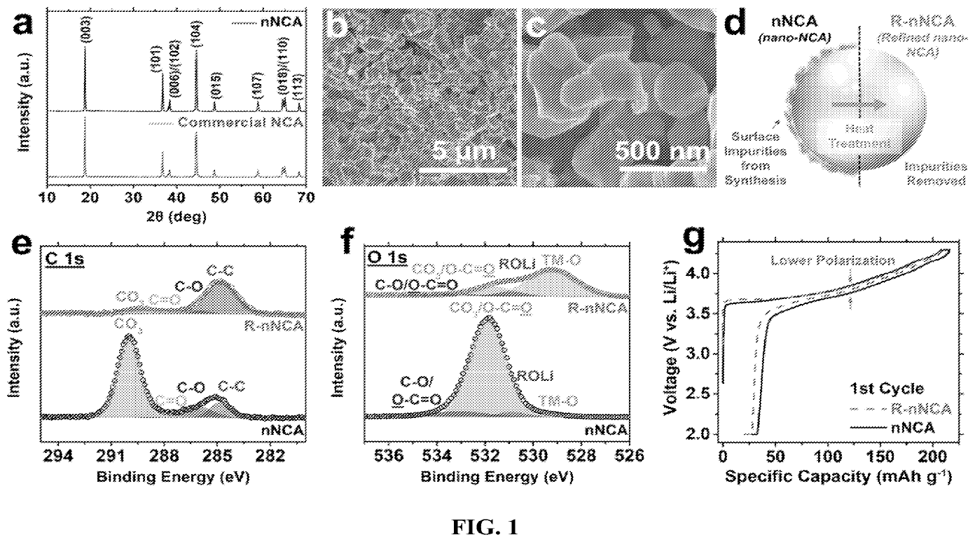

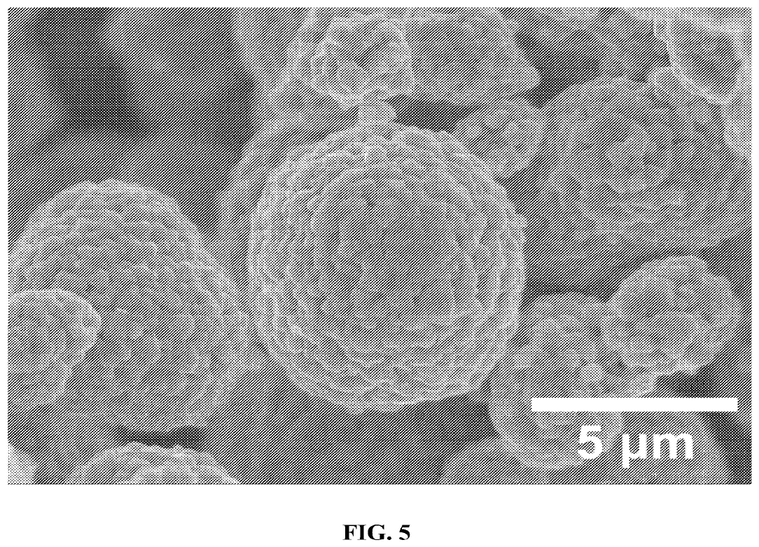

Surface Impurity Characterization: Nanoparticles of NCA (hereafter referred to as nNCA) were synthesized using a solid-state method. To validate the quality of the synthesized nNCA, X-ray diffraction (XRD) was performed to confirm that the solid-state method yielded NCA with a layered crystal structure, as shown in panel a of FIG. 1. The XRD pattern of the synthesized nNCA closely matched the reference pattern obtained from commercial NCA powder and showed no evidence of impurity phases. Furthermore, the splitting of the (006)/(102) peaks and the (018)/(110) peaks provided additional confirmation that the nNCA powder possessed a layered structure. Scanning electron microscopy (SEM) was used to analyze the particle morphology. In contrast to the commercial micron-scale powders, the nNCA powder was comprised of primary NCA nanoparticles less than about 500 nm in diameter, as shown in panels b-c of FIG. 1 and FIG. 5. Together, the XRD and SEM results verified that the solid-state synthesis scheme successfully yielded crystalline NCA nanoparticles.

Although the nNCA powder possessed the desired crystal structure and particle size, a careful analysis of the surface chemistry via X-ray photoelectron spectroscopy (XPS) revealed that impurity compounds were still present on the surface after synthesis. To deconvolute the XPS C 1s spectra, four peaks were assigned: C—C bonds at 284.8 eV, C—O bonds at 286.0 eV, C═O bonds at 288.5 eV, and CO₃ bonds at 290.7 eV. Similarly, the XPS 0 1s spectra was deconvoluted with four peaks: lattice transition metal oxygen bonds at 529.2 eV, ROLi species at 530.9 eV, CO₃/O—C═O bonds at 531.7 eV, and C—O/O—C═O bonds at 533.1 eV. The C—C bonding nature likely originated from adventitious carbon, while the various carbon-oxygen bond signals can be attributed to the acetate and oxalate precursors used for nNCA synthesis. On the other hand, the carbonate and ROLi signals are evidence of impurity compounds formed during synthesis.

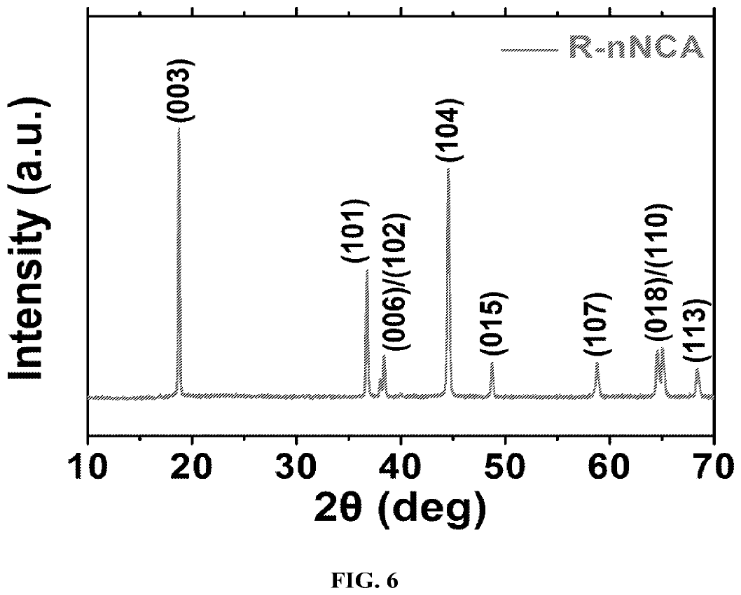

Since XPS revealed evidence for surface impurity species that can likely be removed through mild heating in an oxidizing environment, post-synthetic annealing treatments were explored to produce a more pristine nNCA surface. In particular, annealing at about 250° C. under flowing oxygen gas for about 1 hour effectively refined the nNCA surface (hereafter referred to as R-nNCA, as shown in panel d of FIG. 1). Because heat treatment steps are commonly employed in existing cathode powder synthesis procedures, this refining step can more easily be implemented in practice compared to other reported strategies for removing surface impurities. Importantly, this surface refinement step did not lead to any measurable changes to the bulk structure of the nNCA (FIG. 6). XPS analysis of the originally synthesized nNCA suggested that the surface possessed significant carbonate character (panels e-g of FIG. 1), as evidenced by the peaks at 290.7 eV and 532.1 eV, which is consistent with prior reports. In contrast, after the surface refinement step, the XPS C is and O 1s spectra of the R-nNCA powder revealed that the intensity of the carbonate peaks decreased dramatically. Additionally, the XPS 0 is spectrum of the R-nNCA powder showed an increase in the peak intensity assigned to lattice transition metal-oxygen bonds at 529.8 eV. This intensity increase is consistent with the removal of a surface layer that would otherwise attenuate the transition metal oxide intensity originating in the particle bulk.

To probe the effect of surface impurities on the electrochemical properties of nNCA, electrochemical cycling measurements were performed on the nNCA and R-nNCA samples.

Panel g of FIG. 1 shows that the R-nNCA electrodes experienced lower electrode polarization during activation than the nNCA electrodes. Since a sample with high electrode polarization reaches its upper cutoff voltage with a higher lithium content than expected, a constant voltage hold allows the electrode to finish delithiating close to its thermodynamically defined lithium content. Therefore, a comparison of the capacity gained during the hold steps at constant voltage serves as a measurement of electrode polarization. In particular, the nNCA electrode gained an additional 7.5 mAh/g of capacity during the constant voltage hold at 4.3 V, corresponding to 3.5% of its charge capacity. In contrast, the R-nNCA electrode only gained 1.6 mAh/g during the voltage hold, corresponding to 0.75% of its charge capacity, which confirms that the surface refinement step did indeed lower the electrode polarization. Moreover, the first-cycle efficiency (FCE) for the R-nNCA electrode was 90.4%, whereas the FCE for the nNCA electrode was 87.3%, which shows that the R-nNCA electrode possessed better electrochemical reversibility than the nNCA electrode. This analysis is consistent with prior work, which found that the presence of surface Li₂CO₃ species impedes local reaction kinetics near the carbonate deposits. Overall, these results highlight the importance of carefully assessing and controlling the surface chemistry of nickel-rich cathode materials.

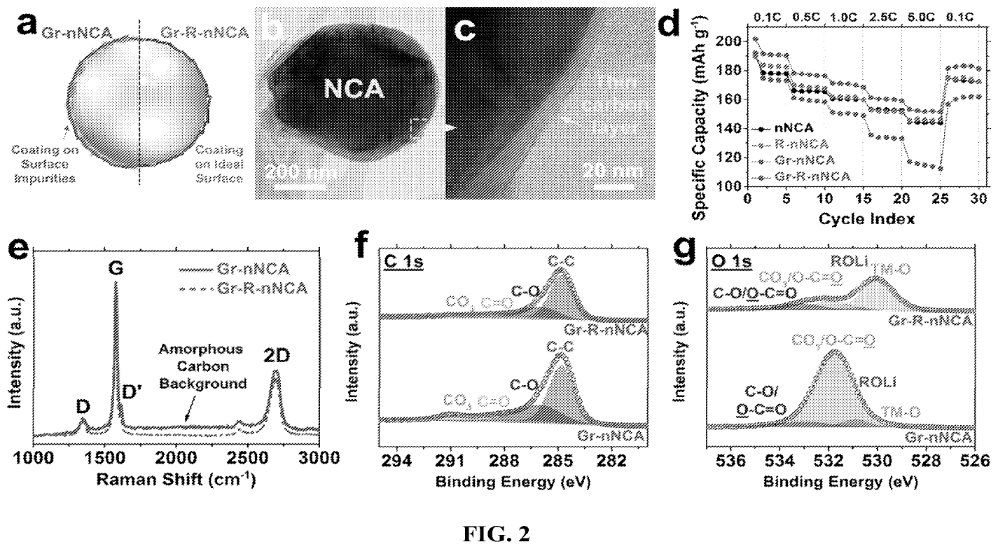

Assessing Graphene Coatings: Surface conductive carbon coating schemes (e.g., conformal graphene coatings) are commonly employed strategies to reduce cell impedance and increase high-rate performance. A solution-phase coating scheme was used to encapsulate the nNCA and R-nNCA particles with a conformal graphene-ethyl cellulose (EC) layer, yielding Gr-nNCA and Gr-R-nNCA, respectively, as shown in panel a of FIG. 2. The thermal decomposition of the EC polymer leaves behind a carbonaceous residue on the active material surface that possesses high sp² character, thus reinforcing the graphitic character of the carbon coating. In addition, this residue is highly electrically conductive, thereby improving the electrical contact between adjacent graphene flakes and enhancing electrochemical cycling.

Following the coating process, transmission electron microscopy (TEM) confirmed the presence of a thin carbon layer on the surface of the NCA particles, as shown in panels b-c of FIG. 2. Since this conformal graphene coating scheme yields a highly percolating, electrically conductive network between the NCA particles, the graphene-coated nNCA (Gr-nNCA) and graphene-coated R-nNCA (Gr-R-nNCA) electrodes were expected to outperform the respective nNCA and R-nNCA control electrodes fabricated with traditional carbon black additives. However, while the Gr-R-nNCA electrode possessed higher initial capacity and better rate capability than the R-nNCA control sample, the Gr-nNCA electrode surprisingly performed considerably worse than the nNCA control electrode, as shown in panel d of FIG. 2. This result suggests that an active material surface that is rich in impurity species, such as carbonates, undermines the effectiveness of carbon coating schemes.

Raman spectroscopy and XPS analysis of the pristine electrode surfaces after thermal decomposition of the EC polymer further corroborated that the quality of the electrode coating depends on the cleanliness of the active material surface. The Raman spectra for the Gr-nNCA and Gr-R-nNCA electrodes revealed a large G/D ratio for both samples, which indicated that both electrodes possessed graphene-like character, as shown in panel e of FIG. 2. However, the Gr-nNCA electrode showed greater evidence of an amorphous carbon background than the Gr-R-nNCA electrode, implying that the presence of the carbonate impurities hindered the formation of the sp²-rich carbonaceous residue during the EC thermal decomposition process. Since EC contains many carbon-based and oxygen-based functional groups, evidence of this bonding character in the graphene-coated electrodes would provide further evidence that surface impurities have adverse impact on EC volatilization. Indeed, the higher relative intensity of the C—O peak in the XPS C is spectrum of the Gr-nNCA electrode compared to the Gr-R-nNCA electrode confirms the difference in amorphous carbon signals between the two electrodes, as shown in panel f of FIG. 2. Furthermore, the XPS C is and O is spectra, as shown in panels f-g of FIG. 2, of the Gr-nNCA electrode showed a much higher carbonate signal than the Gr-R-nNCA electrode, suggesting that these species persisted through the second heat treatment step where the EC polymer is supposed to be decomposed. Since the carbonate species are detrimental to electrochemical cycling, these spectroscopic data are consistent with the electrochemical results that showed the poorest performance for the Gr-nNCA electrode.

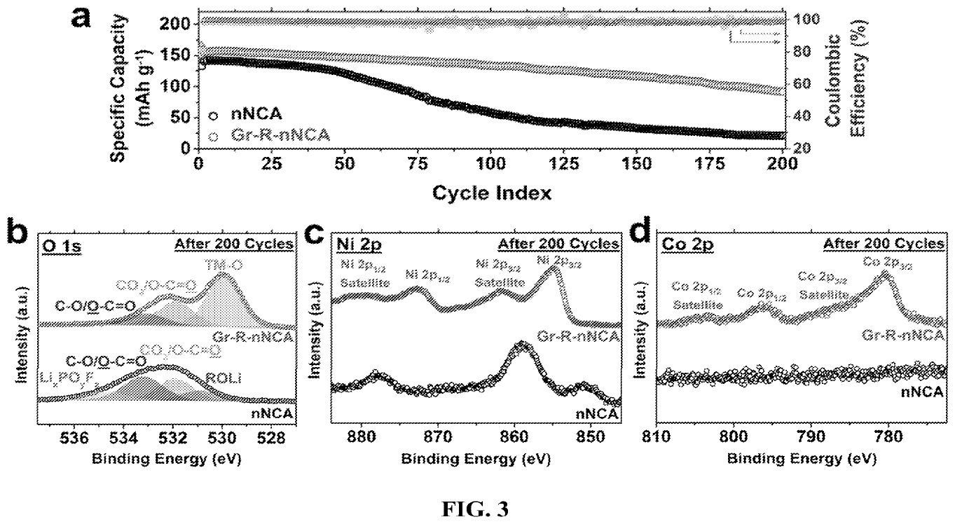

Comparative Electrochemical Characterization: To further assess the combined advantages of surface refinement and conformal graphene coating, additional electrochemical characterization was undertaken. For example, panel a of FIG. 3 shows that surface refinement coupled with the conformal graphene coating significantly improved the cycle life of the NCA material. After 200 cycles at a 1 C cycling rate, the Gr-R-nNCA electrode possessed a capacity of about 91.8 mAh/g, corresponding to about 60.5% capacity retention. In contrast, the nNCA control electrode degraded quickly within the first 100 cycles, ultimately resulting in a capacity of about 21.2 mAh/g after 200 cycles, corresponding to about 15.9% capacity retention.

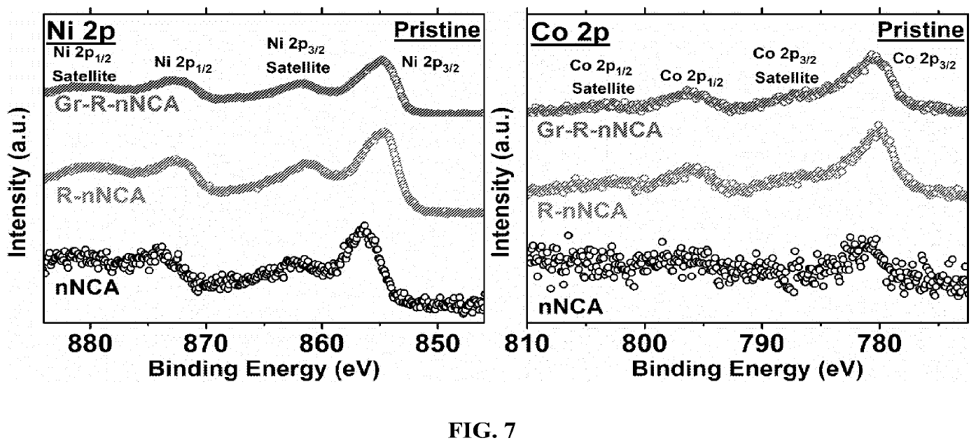

To elucidate the origins of the observed cycle life improvement, postmortem XPS analysis of the cathode surfaces was performed. The XPS 0 is spectra for the Gr-R-nNCA and nNCA samples were fit with the same four component spectra as the pristine electrodes, as well as an additional peak at about 534.7 eV that was assigned to LiₓPO_{y}F_{z} species formed in operando due to electrolyte decomposition, as shown in panel b of FIG. 3. For the nNCA electrode after cycling, the increase in the C—O and C═O spectral peaks, the clear presence of LiₓPO_{y}F_{z} species, the changes in the Ni 2p spectrum compared to the pristine electrode, as shown in panel c of FIG. 3 and FIG. 7, and the absence of any discernable Co 2p signal, as shown in panel d of FIG. 3 and FIG. 7, together suggest that the nNCA surface was coated with a layer during cycling that is rich in organic and fluorophosphate components. The formation of this layer is well known and has been attributed to a ring-opening reaction of the ethylene carbonate solvent, which is assisted by transition metal ions on the cathode surface. Other reported degradation reactions, such as transition metal etching by trace amounts of HF in the electrolyte, may also contribute to the surface degradation in the nNCA electrode.

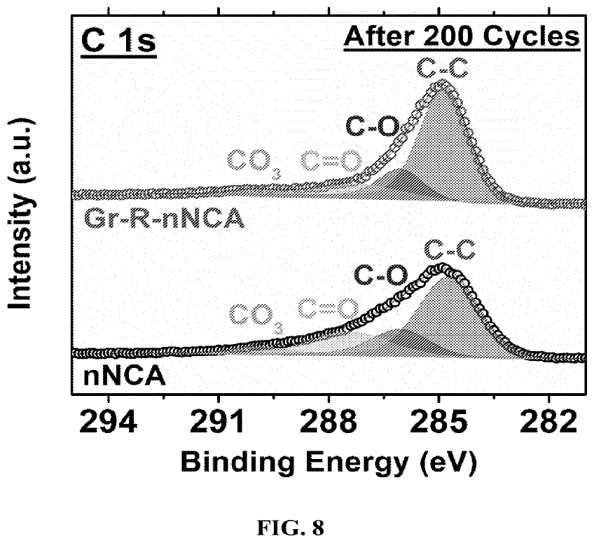

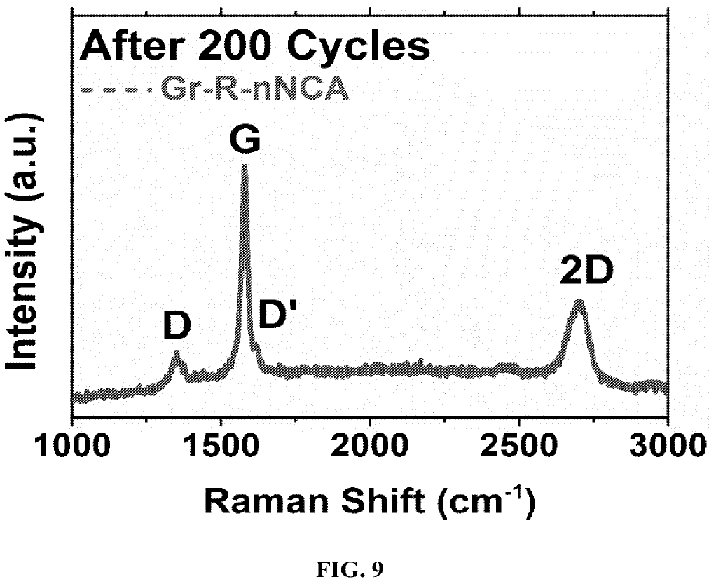

In contrast, fewer changes were observed for the Gr-R-nNCA electrode after cycling. Although some slight increases in the carbon-oxygen bond intensities are observed in the XPS C is and O is spectra, little evidence exists for fluorophosphate degradation products, as shown in panel b of FIG. 3 and FIG. 8. Furthermore, the transition metal oxide signal and the minimal changes in the Ni 2p and Co 2p spectral features for the pristine and postmortem electrodes, as shown in panels c-d of FIG. 3 and FIG. 7 suggest that the Gr-R-nNCA surface did not significantly degrade during cycling. Postmortem Raman spectroscopy of the Gr-R-nNCA electrode also corroborated this conclusion shown in FIG. 9. Even after 200 charge-discharge cycles, the Raman spectrum for the Gr-R-nNCA electrode continues to exhibit a large G/D ratio, which confirms that the electrode maintained its graphene-like character throughout the cycle life test. Small changes in the amorphous carbon background are likely due to organic electrolyte degradation products, which are also present in the XPS C is spectrum. Similar to other electrode coating schemes, the conformal graphene coating in the Gr-R-nNCA electrode apparently acts as a barrier layer that minimizes the interaction between the transition metals in the active material and the electrolyte, effectively mitigating the severity and extent of electrolyte decomposition. Additionally, the graphene coating may act as a scavenger for HF, which would otherwise etch the transition metals near the surface and degrade interfacial charge transport.

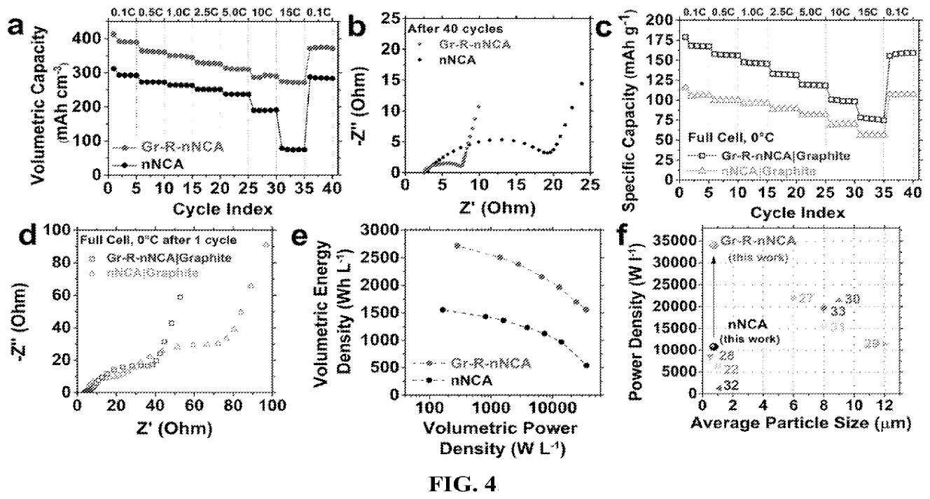

The combination of surface refinement and conformal graphene coating enabled substantial enhancements in numerous other electrochemical performance metrics. Prior work has shown that graphene-coated microparticle electrodes yield large improvements in volumetric capacity due to the replacement of low-density carbon black with a percolating graphene network. Here, the initial volumetric capacities again reflected this phenomenon for nickel-rich nanoparticles. Specifically, the Gr-R-nNCA electrode reached an initial volumetric discharge capacity of about 412.6 mAh/cm³, while the nNCA electrode only reached an initial volumetric discharge capacity of about 311.7 mAh/cm³, as shown in panel a of FIG. 4. The high electrical conductivity of the graphene network also promotes fast electronic transport, while the nanoparticle NCA morphology provides short Li-ion diffusion lengths into the bulk and increases the number of charge transfer reaction sites. Together, these factors significantly improved the high-rate performance of the Gr-R-nNCA electrode compared to the nNCA control sample. When discharged at 15 C, the Gr-R-nNCA electrode possessed a volumetric capacity of about 273 mAh/cm³, while the volumetric capacity of the nNCA control electrode dramatically dropped to about 78.5 mAh/cm³. Electrochemical impedance spectroscopy was also performed on the electrodes after cycling at different current rates to confirm the enhancement in charge transport behavior. The Nyquist plots showed that the Gr-R-nNCA electrode possessed substantially lower cell impedance (about 5Ω) than the nNCA electrode (about 15Ω), thereby corroborating the rate capability results, as shown in panel b of FIG. 4.

To test the limits of the Gr-R-nNCA electrode, full cells were assembled and subjected to galvanostatic cycling at 0° C. Under these conditions, the amount of lithium in the full cell is restricted to the capacity possessed by the cathode, implying that parasitic side reactions that irreversibly consume lithium become even more deleterious. Furthermore, ionic charge transport is more sluggish at low temperatures, which reduces discharge capacities, particularly at high applied current rates. Despite these harsh testing conditions, the Gr-R-nNCA|Graphite full cell showed impressive electrochemical performance. Specifically, at all current rates, the Gr-R-nNCA|Graphite full cell possessed higher capacities than the nNCA|Graphite full cell, as shown in panel c of FIG. 4. The Nyquist plot further showed that the lower impedance observed in the half-cell geometry tested at room temperature was again evident for the full cell at 0° C., as shown in panel d of FIG. 4. The smaller high-frequency arcs for the Gr-R-nNCA|Graphite sample suggest that both the surface film and charge transfer impedances were lower than the nNCA control sample, indicating that interfacial charge transport was significantly improved by the graphene coating.

The high volumetric capacity superlative rate capability enabled by surface refinement and conformal graphene coating correspondingly led to substantial improvements in the energy and power densities. These enhancements are evident on a Ragone plot, as shown in panel e of FIG. 4, which shows that the Gr-R-nNCA sample clearly outperformed the nNCA control sample. Additionally, the exceptionally high volumetric power density for the Gr-R-NCA sample compares favorably to literature precedent for NCA-based cathodes, as shown in panel f of FIG. 4. Overall, these results establish that Gr-R-nNCA cathodes enable high-performance LIBs with long cell lifetimes, high rate capability, and wide operating temperature windows.

In summary, the surface chemistry of nanoscale nickel-rich cathode particles was explored to identify and remove residual contaminants from solid-state synthesis. The resulting chemically pristine nanoparticles were more amenable to a conformal graphene coating, ultimately resulting in a nanoparticle-based electrode with exceptional electrochemical properties. Specifically, the surface refinement and conformal graphene coating enabled superlative performance in LIBs including high rate capability, low impedance, high volumetric energy and power densities, and long cycle life. In addition, these nanostructured cathode materials widened the LIB operating range, particularly at low temperatures. While demonstrated here for nickel-rich LIB cathodes, this methodology can likely be generalized to other energy storage electrodes, such as sodium-ion or magnesium-ion batteries, that incorporate nanostructured materials possessing high surface area. Therefore, this work establishes a well-defined path forward for the realization of high-performance, nanoparticle-based energy storage devices.

The foregoing description of the exemplary embodiments of the invention has been presented only for the purposes of illustration and description and is not intended to be exhaustive or to limit the invention to the precise forms disclosed. Many modifications and variations are possible in light of the above teaching.

The embodiments were chosen and described in order to explain the principles of the invention and their practical application so as to enable others skilled in the art to utilize the invention and various embodiments and with various modifications as are suited to the particular use contemplated. Alternative embodiments will become apparent to those skilled in the art to which the invention pertains without departing from its spirit and scope. Accordingly, the scope of the invention is defined by the appended claims rather than the foregoing description and the exemplary embodiments described therein.

Some references, which may include patents, patent applications, and various publications, are cited and discussed in the description of this invention. The citation and/or discussion of such references is provided merely to clarify the description of the invention and is not an admission that any such reference is “prior art” to the invention described herein. All references cited and discussed in this specification are incorporated herein by reference in their entireties and to the same extent as if each reference was individually incorporated by reference.

### LIST OF REFERENCES

[1]. W. Li, E. M. Erickson, and A. Manthiram, Nat. Energy 5, 26 (2020).
[2]. S. T. Myung, F. Maglia, K. J. Park, C. S. Yoon, P. Lamp, S. J. Kim, and Y. K. Sun, ACS Energy Lett. 2, 196 (2017).
[3]. Y. Xia, J. Zheng, C. Wang, and M. Gu, Nano Energy 49, 434 (2018).
[4]. Y. Talyosef, B. Markovsky, R. Lavi, G. Salitra, D. Aurbach, D. Kovacheva, M. Gorova, E. Zhecheva, and R. Stoyanova, J. Electrochem. Soc. 154, A682 (2007).
[5]. G. V. Zhuang, G. Chen, J. Shim, X. Song, P. N. Ross, and T. J. Richardson, J. Power Sources 134, 293 (2004).
[6]. S. E. Renfrew and B. D. McCloskey, J. Am. Chem. Soc. 139, 17853 (2017).
[7]. A. Grenier, H. Liu, K. M. Wiaderek, Z. W. Lebens-Higgins, O. J. Borkiewicz, L. F. J. Piper, P. J. Chupas, and K. W. Chapman, Chem. Mater. 29, 7345 (2017).
[8]. C. Wang, L. Shao, X. Guo, X. Xi, L. Yang, C. Huang, C. Zhou, H. Zhao, D. Yin, and Z. Wang, ACS Appl. Mater. Interfaces 11, 44036 (2019).
[9]. M. Gauthier, T. J. Carney, A. Grimaud, L. Giordano, N. Pour, H. Chang, D. P. Fenning, S. F. Lux, O. Paschos, C. Bauer, F. Maglia, S. Lupart, P. Lamp, and Y. Shao-Horn, J. Phys. Chem. Lett. 6, 4653 (2015).
[10]. Y. Yu, P. Karayaylali, Y. Katayama, L. Giordano, M. Gauthier, F. Maglia, R. Jung, I. Lund, and Y. Shao-Horn, J. Phys. Chem. C 122, 27368 (2018).
[11]. L. Giordano, P. Karayaylali, Y. Yu, Y. Katayama, F. Maglia, S. Lux, and Y. Shao-Horn, J. Phys. Chem. Lett. 8, 3881 (2017).
[12]. S. Ramakrishnan, B. Park, J. Wu, W. Yang, and B. D. McCloskey, J. Am. Chem. Soc. 142, 8522 (2020).
[13]. S. E. Renfrew, L. A. Kaufman, and B. D. McCloskey, ACS Appl. Mater. Interfaces 11, 34913 (2019).
[14]. J. C. Jones, S. Rajendran, A. Pilli, V. Lee, N. Chugh, L. M. R. Arava, and J. A. Kelber, J. Vac. Sci. Technol. A 38, 023201 (2020).
[15]. D. Mohanty, K. Dahlberg, D. M. King, L. A. David, A. S. Sefat, D. L. Wood, C. Daniel, S. Dhar, V. Mahajan, M. Lee, and F. Albano, Sci. Rep. 6, 26532 (2016).
[16]. G. Dai, H. Du, S. Wang, J. Cao, M. Yu, Y. Chen, Y. Tang, A. Li, and Y. Chen, RSC Adv. 6, 100841 (2016).
[17]. Y. Cho and J. Cho, J. Electrochem. Soc. 157, A625 (2010).
[18]. Y. Huang, Y. Huang, and X. Hu, Electrochim. Acta 231, 294 (2017).
[19]. K.-S. Chen, R. Xu, N. S. Luu, E. B. Secor, K. Hamamoto, Q. Li, S. Kim, V. K. Sangwan, I. Balla, L. M. Guiney, J.-W. T. Seo, X. Yu, W. Liu, J. Wu, C. Wolverton, V. P. Dravid, S. A. Barnett, J. Lu, K. Amine, and M. C. Hersam, Nano Lett. 17, 2539 (2017).
[20]. J.-M. Lim, S. Kim, N. S. Luu, J. R. Downing, M. T. Z. Tan, K.-Y. Park, J. C. Hechter, V. P. Dravid, K. He, and M. C. Hersam, Matter 3, 522 (2020).
[21]. K.-Y. Park, J.-M. Lim, N. S. Luu, J. R. Downing, S. G. Wallace, L. E. Chaney, H. Yoo, W. J. Hyun, H. U. Kim, and M. C. Hersam, Adv. Energy Mater. 10, 2001216 (2020).
[22]. Z. Qiu, Y. Zhang, P. Dong, S. Xia, and Y. Yao, Solid State Ionics 307, 73 (2017).
[23]. R. T. Haasch and D. P. Abraham, Surf. Sci. Spectra 26, 014003 (2019).
[24]. E. B. Secor, P. L. Prabhumirashi, K. Puntambekar, M. L. Geier, and M. C. Hersam, J. Phys. Chem. Lett. 4, 1347 (2013).
[25]. R. Dedryvère, H. Martinez, S. Leroy, D. Lemordant, F. Bonhomme, P. Biensan, and D. Gonbeau, J. Power Sources 174, 462 (2007).
[26]. X. Yang, J. Chen, Q. Zheng, W. Tu, L. Xing, Y. Liao, M. Xu, Q. Huang, G. Cao, and W. Li, J. Mater. Chem. A 6, 16149 (2018).
[27]. M. J. Lee, M. Noh, M. H. Park, M. Jo, H. Kim, H. Nam, and J. Cho, J. Mater. Chem. A 3, 13453 (2015).
[28]. Y. Li, H. Yu, Y. Hu, H. Jiang, and C. Li, J. Energy Chem. 27, 559 (2018).
[29]. X. He, X. Xu, L. Wang, C. Du, X. Cheng, P. Zuo, Y. Ma, and G. Yin, J. Electrochem. Soc. 166, A143 (2019).
[30]. C. H. Lai, D. S. Ashby, T. C. Lin, J. Lau, A. Dawson, S. H. Tolbert, and B. S. Dunn, Chem. Mater. 30, 2589 (2018).
[31]. N. Wu, H. Wu, W. Yuan, S. Liu, J. Liao, and Y. Zhang, J. Mater. Chem. A 3, 13648 (2015).
[32]. K. S. Ryu, S. H. Lee, B. K. Koo, J. W. Lee, K. M. Kim, and Y. J. Park, J. Appl. Electrochem. 38, 1385 (2008).
[33]. J. H. Shim, Y. M. Kim, M. Park, J. Kim, and S. Lee, ACS Appl. Mater. Interfaces 9, 18720 (2017).
[34]. A. Zhamu et al., Graphene-enhanced cathode materials for lithium batteries, U.S. Pat. No. 8,691,441 B2 (2010).
[35]. A. Zhamu et al., Nano graphene reinforced nanocomposite particles for lithium battery electrodes, U.S. Publication No. US2010/0143798 A1 (2008).
[36]. D. H. Adamson et al., Graphene/graphite polymer composite foam derived from emulsions stabilized by graphene/graphite kinetic trapping, PCT Publication No. WO2015/184155 A1 (2015).
[37]. S. A. Miller, Coating a substance with graphene, U.S. Pat. No. 8,691,335 B2 (2010).
[38]. A. Zhamu et al., Method of producing multi-level graphene-protected active material particles for battery applications, U.S. Pat. No. 10,559,815 B2 (2018).
[39]. K. Amine and A. Abouimrane, Coated electroactive materials, U.S. Pat. No. 9,431,649 B2 (2010).
[40]. Y. Wang et al., Active material-coated discrete graphene sheets for lithium batteries and process for producing same, U.S. Pat. No. 9,203,084 B2 (2013).
[41]. N. Li, Y. Wang, R. Rao, X. Dong, X. Zhang, S. Zhu. The preparation and graphene surface coating NaTi₂(PO₄)₃ as cathode material for lithium ion batteries (2017) Applied Surface Science Volume 399, Pages 624-629.
[42]. K.-S. Chen, R. Xu, N. S. Luu, E. B. Secor, K. Hamamoto, Q. Li, S. Kim, V. K. Sangwan, I. Balla, L. M. Guiney, J.-W. T. Seo, X. Yu, W. Liu, J. Wu, C. Wolverton, V. P. Dravid, S. A. Barnett, J. Lu, K. Amine, and M. C. Hersam. Comprehensive Enhancement of Nanostructured Lithium-Ion Battery Cathode Materials via Conformal Graphene Dispersion (2017) Nano Letters, 17, 4, 2539-2546.
[43]. X. He, X. Xu, L. Wang, C. Du, X. Cheng, P. Zuo, Y. Ma, G. Yin. Enhanced Electrochemical Performance of LiNi_{0.8}Co_{0.15}Al_{0.05}O₂ Cathode Material via Li₂TiO₃ Nanoparticles Coating (2019) J. Electrochem. Soc. 166 A143.
[44]. Z. Qiu, Y. Zhang, P. Dong, S. Xia, Y. Yao. A facile method for synthesis of LiNi_{0.8}Co_{0.15}Al_{0.05}O₂ cathode material, Solid State Ionics 307 (2017) 73-78.
[45]. K.-Y. Park, J.-M. Lim, N. S. Luu, J. R. Downing, S. G. Wallace, L. E. Chaney, H. Yoo, W. J. Hyun, H. U. Kim, and M. C. Hersam. Concurrently Approaching Volumetric and Specific Capacity Limits of Lithium Battery Cathodes via Conformal Pickering Emulsion Graphene Coatings, (2020), Advanced Energy Materials, Vol. 10 (25), 2001216.

1. A composite for an electrode for an electrochemical device, comprising:
nanoparticles of an active material, said nanoparticles being surface refined by a post-synthetic annealing treatment to remove or minimize surface impurities thereon; and
conformal graphene coating on each surface of said nanoparticles.

2. The composite of claim 1, wherein the active material comprises nickel-rich transition metal oxides, cobalt-rich transition metal oxides, and lithium-rich transition metal oxides.

3. The composite of claim 2, wherein the nickel-rich transition metal oxides comprise nickel-rich lithium oxides, nickel-rich sodium oxides, or nickel-rich magnesium oxides.

4. The composite of claim 3, wherein the nickel-rich lithium oxides comprise LiNi_{0.8}Co_{0.15}Al_{0.05}O₂ (NCA), LiNiO₂ (LNO), LiMn_{1.5}Ni_{0.5}O₄ (LMNO), LiNiₓMn_{y}Co_{z}O₂ (NMC, wherein x+y+z=1), LiNi_{0.8}Co_{0.2}O₂ (LNCO), or Li_{w}NiₓMn_{y}Co_{z}O₂ (lithium-rich NMC, wherein w >1, x+y+z=1).

5. The composite of claim 4, wherein the nickel-rich lithium oxides are doped with elements including Al, B, Zr, Nb, Fe, Cr, Cu, Mo, W, and/or V.

6. The composite of claim 1, wherein the post-synthetic annealing treatment is performed by annealing at a temperature in a range of about 150-350° C. in an oxidizing environment for about 0.5-2 hours to effectively refine the surfaces of said nanoparticles.

7. The composite of claim 6, wherein the post-synthetic annealing treatment does not produce any measurable changes to a bulk structure of said nanoparticles.

8. The composite of claim 1, wherein the graphene comprises solution-exfoliated graphene.

9. The composite of claim 1, wherein the conformal graphene coating yields a highly percolating, electrically conductive network between said nanoparticles.

10. The composite of claim 1, further comprising amorphous carbon with sp²-carbon content.

11. The composite of claim 10, wherein the amorphous carbon is an annealation product of ethyl cellulose.

12. The composite of claim 11, being formed by annealing a mixture of said nanoparticles, said graphene, and ethyl cellulose at a temperature for a period of time to decompose the ethyl cellulose, thereby resulting in said composite having said annealation product of the ethyl cellulose.

13. An electrode for an electrochemical device, comprising:
said composite of claim 1.

14. The electrode of claim 13, wherein the electrode has superlative performance including high rate capability, low impedance, high volumetric energy and power densities, and long cycle life, compared with a control electrode that comprises nanoparticles of the active material without surface refining and/or conformal graphene coating.

15. The electrode of claim 14, wherein the electrode has electrode polarization during activation lower than that of the control electrode.

16. The electrode of claim 14, wherein the electrode has initial capacity and rate capability better than that of the control electrode.

17. The electrode of claim 14, wherein the electrode has electrochemical reversibility better than that of the control electrode.

18. The electrode of claim 14, wherein the electrode has cell impedance substantially lower than that of the control electrode.

19. An electrochemical device, comprising the electrode of claim 13.

20. A method for forming a composite for an electrode for an electrochemical device, comprising:
providing nanoparticles of an active material;
annealing said nanoparticles to remove or minimize surface impurities thereon to form surface refined nanoparticles;
forming a mixture comprising said surface refined nanoparticles, graphene, and ethyl cellulose; and
annealing the mixture to decompose the ethyl cellulose, thereby resulting in said composite having a conformal graphene coating on each surface of said surface fined nanoparticles.

21. The method of claim 20, wherein said annealing said nanoparticles comprises annealing said nanoparticles at a temperature in a range of about 150-350° C. in an oxidizing environment for about 0.5-2 hours to effectively refine the surfaces of said nanoparticles.

22. The method of claim 20, wherein said annealing the mixture comprises annealing the mixture at a temperature in a range of about 150-350° C. for about 0.5-2 hours to effectively decompose the ethyl cellulose.

23. The method of claim 20, wherein the graphene comprises solution-exfoliated graphene.

24. The method of claim 20, wherein the active material comprises nickel-rich transition metal oxides.

25. The method of claim 24, wherein the nickel-rich transition metal oxides comprise nickel-rich lithium oxides, nickel-rich sodium oxides, or nickel-rich magnesium oxides.

26. The method of claim 25, wherein the nickel-rich lithium oxides comprise LiNi_{0.8}Co_{0.15}Al_{0.05}O₂ (NCA), LiNiO₂ (LNO), LiMn_{1.5}Ni_{0.5}O₄ (LMNO), LiNiₓMn_{y}Co_{z}O₂ (NMC, wherein x+y+z=1), LiNi_{0.8}Co_{0.2}O₂ (LNCO), or Li_{w}NiₓMn_{y}Co_{z}O₂ (lithium-rich NMC, wherein w >1, x+y+z=1).

27. The method of claim 26, wherein the nickel-rich lithium oxides are doped with elements including Al, B, Zr, Nb, Fe, Cr, Cu, Mo, W, and/or V.

28. A method for forming an electrode for an electrochemical device, comprising:
providing nanoparticles of an active material;
annealing said nanoparticles to remove or minimize surface impurities thereon to form surface refined nanoparticles;
forming a slurry comprising said surface refined nanoparticles, graphene, ethyl cellulose (EC), and a carbon material;
casting the slurry onto a substrate and drying the casted slurry to form an electrode; and
annealing the electrode to decompose the EC, thereby resulting in each surface of said surface refined nanoparticles coupled to and conformally coated with the graphene.

29. The method of claim 28, wherein said annealing said nanoparticles comprises annealing said nanoparticles at a temperature in a range of about 150-350° C. in an oxidizing environment for about 0.5-2 hours to effectively refine the surfaces of said nanoparticles.

30. The method of claim 28, wherein said annealing the electrode comprises annealing the electrode at a temperature in a range of about 150-350° C. for about 0.5-2 hours to effectively decompose the ethyl cellulose.

31. The method of claim 28, wherein said annealing the electrode to decompose the EC results in a carbonaceous residue on the active material surface that possesses sp²-carbon content.

32. The method of claim 28, wherein the graphene comprises solution-exfoliated graphene.

33. The method of claim 28, wherein the substrate comprises an aluminum foil, or the like.

34. The method of claim 28, wherein the carbon material comprises multiwalled carbon nanotubes (MWCNT), single-walled carbon nanotubes (SWCNT), fullerenes, or carbon black.

35. The method of claim 34, wherein a weight ratio of solids in the slurry is about 95% surface refined nanoparticles, about 4.5% graphene, and about 0.5% MWCNT.

36. The method of claim 28, wherein the active material comprises nickel-rich transition metal oxides.

37. The method of claim 36, wherein the nickel-rich transition metal oxides comprise nickel-rich lithium oxides, nickel-rich sodium oxides, or nickel-rich magnesium oxides.

38. The method of claim 37, wherein the nickel-rich lithium oxides comprise LiNi_{0.8}Co_{0.15}Al_{0.05} O₂ (NCA), LiNiO₂ (LNO), LiMn_{1.5}Ni_{0.5}O₄ (LMNO), LiNiₓMn_{y}Co_{z}O₂ (NMC, wherein x+y+z=1), LiNi_{0.8}Co_{0.2}O₂ (LNCO), or Li_{w}NiₓMn_{y}Co_{z}O₂ (lithium-rich NMC, wherein w >1, x+y+z=1).

39. The method of claim 38, wherein the nickel-rich lithium oxides are doped with elements including Al, B, Zr, Nb, Fe, Cr, Cu, Mo, W, and/or V.
